(19) United States
(12) Patent Application Publication
(10) Pub. No.: US 2006/0263117 A1
(43) Pub. Date: Nov. 23, 2006

(54) Doctor blade and development unit having the same

(75) Inventors: Young-min Kim, Suwon-si (KR); Joo-hwan Noh, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/414,329

(22) Filed: May 1, 2006

(30) Foreign Application Priority Data
May 23, 2005 (KR) 2005-43038

(51) Int. Cl. G03G 15/08

(52) U.S. Cl. 399/284

(57) ABSTRACT

A doctor blade and a development unit having the same are disclosed. The doctor blade includes: an elastic blade having one edge contacting a developer roller with a predetermined pressure to control a toner layer formed on the developer roller; and a supporting member supporting the other edge portion of the elastic blade, wherein a middle portion of the supporting member is larger than each end portion of the supporting member. Accordingly, contact pressure between the elastic blade and the developer roller is uniformly distributed along a length direction of the elastic blade.

### CROSS-REFERENCE TO RELATED APPLICATIONS

This application claims the benefit of Korean Patent Application No. 2005-43038, filed May 23, 2005, in the Korean Intellectual Property Office, the disclosure of which is incorporated herein by reference.

### BACKGROUND OF THE INVENTION

1. Field of the Invention

Aspects of the present invention relate to a doctor blade and a development unit using the same in an electro-photographic type image forming apparatus such as a printer, a copier or a facsimile.

2. Description of the Related Art

An electro-photographic type image forming apparatus forms an image on a print medium, such as a paper, when a signal such as a video signal is received from a host, such as a computer. In order to form the image on the print medium, the electro-photographic type image forming apparatus irradiates a laser beam on a photoconductor according to the video signal to form an electrostatic latent image on the photoconductor. The electrostatic latent image is developed using a toner to form a toner image, and the toner image is transferred to a surface of the print medium. Finally, the electro-photographic type image forming apparatus outputs the print medium with the image formed thereon.

FIG. 1 shows a development unit according to the related art.

Referring to FIG. 1, the development unit includes: a photoconductor 1; a developer roller 2; and a doctor blade 10. The developer roller 2 is rotatably disposed to face the photoconductor 1. The doctor blade 10 forms a toner layer with a constant thickness on the developer roller 2 by controlling a thickness of toner supplied to the developer roller 2. The doctor blade 10 adheres closely to the developer roller 2 to control the thickness of toner applied to the developer roller 2. Ordinarily, the toner in a toner cartridge is supplied to the developer roller 2 by a toner supply roller (not shown).

FIG. 2 shows another view of the doctor blade 10 shown in FIG. 1.

As shown in FIG. 2, the doctor blade 10 includes a supporting member 11 having a predetermined width and length; an elastic blade 12 having one edge portion fixed to the supporting member 11 and the other edge portion elastically contacted to the developer roller 2; and seal members 13, 13′ arranged at each end of the elastic blade 12. The supporting member 11 adheres to a development unit frame (not shown), and the elastic blade 12 is connected to the supporting member 11 by an adhesive or weld.

Such a doctor blade 10 is designed to uniformly distribute a contact pressure of the elastic blade 12 along the entire length of the developer roller 2. If the contact pressure is not uniformly distributed, the toner will not be uniformly distributed, that is, the toner will be supplied on the developer roller 2 with neither a constant electric potential nor a constant thickness. As a result, concentration of toner across an image formed on the print medium becomes uneven giving the image an unintended partially washed-out and/or partially bolded appearance.

Although the doctor blade 10 is designed to uniformly distribute the contact pressure, according to the related art, the doctor blade 10 produces a non-uniform contact pressure distribution (A) between the developer roller 2 and the elastic blade 12 because of added pressure on the elastic blade 12 from the seal members 13, 13′ which are mounted at each end of the elastic blade 12 to prevent leakage of the toner as shown in FIG. 2. More specifically, the seal members 13, 13′ are supported by the development unit frame (not shown), and the seal members 13, 13′ bear down on each respective end of the elastic blade 12, thus exerting an additional pressure on both ends of the elastic blade 12. Accordingly, the contact pressure on both end portions of the elastic blade 12 becomes greater than on a middle portion of the elastic blade 12. Therefore, images may be lightly formed on a left side and a right side of the print medium due to lighter concentrations of toner in these areas because the thickness of the toner layer formed on the end portions of the developer roller 2 is overly limited by the additional pressure from the seal members 13, 13′. Further, since images are normally formed on the middle portion of the print medium, this is where the target toner concentration or image contrast is set, thus the additional pressure on the elastic blade 12 from the seal members 13, 13′ typically results in printed images having washed-out side portions. In other words, the non-uniform distribution of contact pressure A causes an uneven toner distribution on the developer roller 2 and a corresponding image concentration, i.e., contrast, problem in the printed images.

### SUMMARY OF THE INVENTION

Accordingly, aspects of the present invention provide a solution to the above-mentioned and/or other problems, among other benefits. An aspect of the present invention provides a doctor blade of an image forming apparatus to uniformly maintain a contact pressure between an elastic blade and a developer roller to resolve uneven image concentration problems.

Additional aspects and/or advantages of the invention will be set forth in part in the description which follows and, in part, will be obvious from the description, or may be learned by practice of the invention.

An aspect of the present invention provides a development unit having the doctor blade to uniformly maintain a contact pressure between an elastic blade and a developer roller to resolve uneven image concentration problems and improve image quality.

In accordance with an aspect of the present invention, there is provided a doctor blade of an image forming apparatus including: an elastic blade having one edge portion in contact with a developer roller with a predetermined pressure to control a toner layer formed on the developer roller; and a supporting member supporting the other edge portion of the elastic blade, wherein a size of a middle portion of the supporting member is larger than the size of each end portion of the supporting member.

According to an aspect of the present invention, the supporting member may be divided into three portions in a length direction, which are the two end portions and the middle portion, where the size of the middle portion of the supporting member is larger than the size of each end portion of the supporting member.

According to an aspect of the present invention, the width of the middle portion of the supporting member may be greater than the width of each end portion of the supporting member. The middle portion of the supporting member may project or protrude along the elastic blade farther than both end portions of the supporting member by a predetermined distance. The projected middle portion of the supporting member may form as a curved-line or a straight-line shaped edge. The additional width of the projected portion may be set less than 40% of a distance L, where L is the distance from an end portion of the supporting member to the contact edge portion of the elastic blade, and the additional width of the projected portion may be about 20% of the distance L.

Another aspect of the present invention provides, a doctor blade of an image forming apparatus including: an elastic blade having one edge portion in contact with a rotating developer roller with a predetermined pressure to control a thickness of a toner layer on the developer roller; a supporting member supporting the other edge portion of the elastic member; and a seal member mounted on each end of the elastic blade to prevent leakage of the toner, wherein the size of the middle portion of the supporting member is larger than a size of each end portion of the supporting member to uniformly distribute contact pressure between the elastic blade and the developer roller along a length direction of the developer roller.

According to an aspect of the present invention, there is provided a development unit including: a developer roller rotatably arranged to face a photoconductor; an elastic blade having one edge portion in contact with the rotating developer roller to control a thickness of a toner layer on the developer roller; a supporting member supporting the other edge portion of the elastic blade, wherein one side of a middle portion of the supporting member may protrude along the elastic blade farther than each end portion of the supporting member by a predetermined distance to exert a higher elastic stress in the elastic blade along the middle portion to cause the contact pressure between the elastic blade and the developer roller to be uniform along the length of the developer roller; and seal members respectively mounted at each end of the elastic blade to prevent leakage of the toner.

According to an aspect of the present invention, the supporting member has a middle portion having a larger size than both end portions. According to an aspect of the present invention, the width of the middle portion of the supporting member may be larger than the widths of the end portions of the supporting member. The additional width of the middle portion of the supporting member may be projected along the elastic blade farther than both end portions of the supporting member. The projected portion of the supporting member may form a curved-line or a straight-line shaped edge. The additional width of the projected portion may be projected less than 40% of a distance L measured from an end portion of the supporting member to the edge of the elastic blade contacting the developer roller, and the additional width may be about 20% of the distance L.

According to an aspect of the present invention, the supporting member and the elastic blade are joined by an adhesive, a weld or a fastener.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic view illustrating a development unit with a doctor blade according to the related art;

FIG. 2 is a view showing a contact pressure distribution A between an elastic blade and a developer roller shown in FIG. 1;

FIG. 3 is a schematic view depicting a development unit having a doctor blade according to an embodiment of the present invention;

FIG. 4 shows a contact pressure distribution B between an elastic blade and a developer roller shown in FIG. 3; and

FIG. 5 shows a doctor blade and contact pressure distribution B according to another embodiment of the present invention.

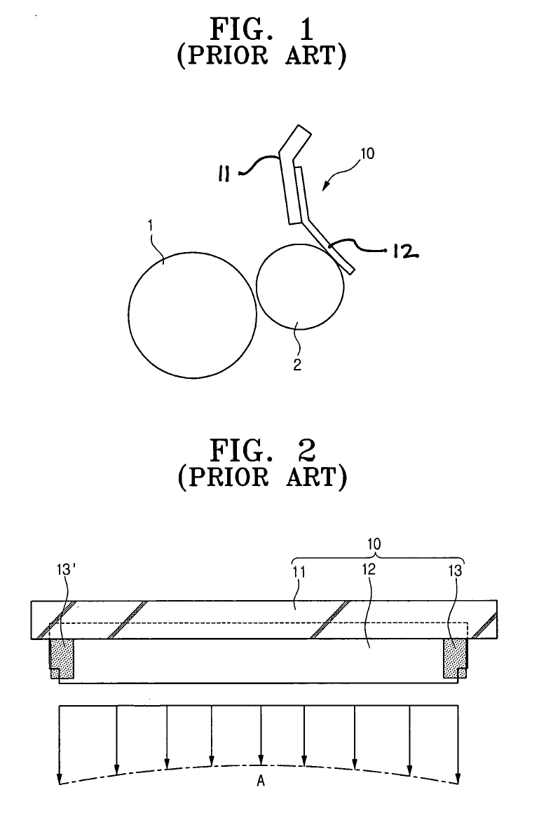

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

The matters defined in the description such as a detailed construction and elements are nothing more than that needed to assist in a comprehensive understanding of the invention. Thus, it is apparent that the present invention can be carried out without these defined matters. Also, well-known functions or constructions to one of skill in the art are not described in detail since they would obscure the invention in unnecessary detail.

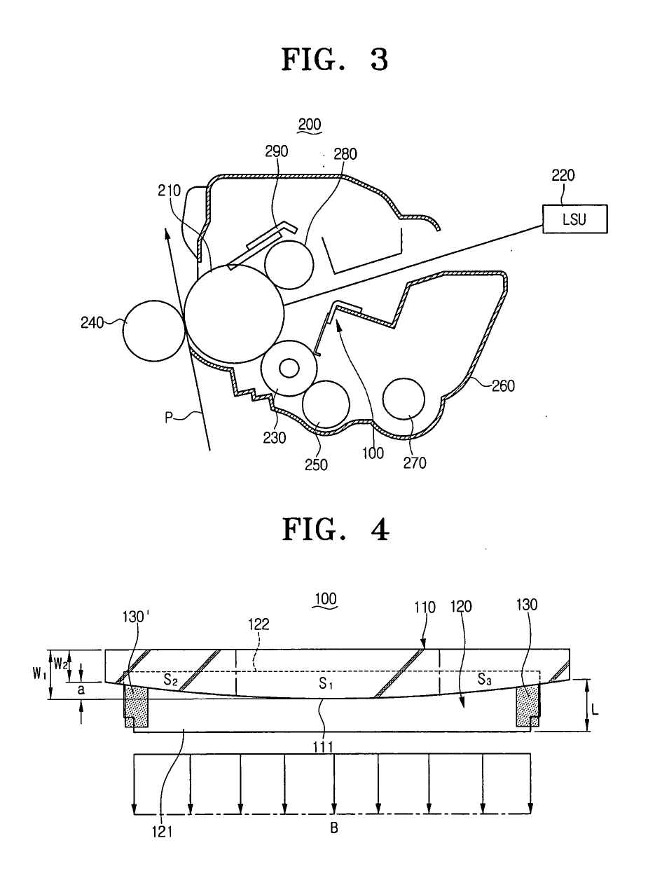

FIG. 3 is a schematic view depicting a development unit having a doctor blade according to an embodiment of the present invention, and FIG. 4 shows a contact pressure distribution between an elastic blade and a developer roller shown in FIG. 3.

Referring to FIGS. 3 and 4, a laser beam is irradiated according to a signal from a laser scanning unit 220 on a photoconductor 210 to form a predetermined electrostatic latent image on the photoconductor 210. A developer roller 230 supplies a toner to the photoconductor 210 to develop the electrostatic latent image, and the developed toner image is transferred onto a print medium P which travels between the photoconductor 210 and a transfer roller 240. As shown in FIG. 3, the development unit also includes: a toner supply roller 250 for supplying the toner in a toner case 260; an agitator 270, a cleaning roller 280, and a cleaning blade 290. As described above, the doctor blade 100 controls the thickness of the toner supplied from the toner supply roller 250 to the developer roller 230 to form a toner layer with a constant thickness on the developer roller 230. As shown in FIG. 4, the doctor blade 100 includes a supporting member 110, an elastic blade 120 and a pair of seal members 130 and 130′.

The supporting member 110 according to the present embodiment is designed to have a middle portion S1 having a larger size than both side portions S2 and S3. This is because each seal member 130, 130′ exerts additional pressurize on its respective end of the elastic blade 120 which causes an increase in the elastic stress in the elastic blade 120 at the ends and a corresponding increase in the contact pressure at both ends of the elastic blade 120. The larger middle portion S1 of the supporting member 110 increases the elastic stress of the middle portion of the elastic blade 120 to uniformly distribute the contact pressure along the entire length of the contact between the elastic blade 120 and the developer roller 230.

As described above, in the present embodiment the width W1 of the middle portion S1 of the supporting member 110 is wider by a predetermined amount than the width W2 of the end portions S2 and S3 of the supporting member 110. In more detail, the middle portion S1 of the supporting member 110 is projected farther along the elastic blade 120 toward a contact edge 121 of the elastic blade 120 by a distance “a” compared to the end portions S2 and S3 of the supporting member 110. Thus decreasing a distance from the middle portion S1 projected edge 111 to the contact edge 121 to increase the contact pressure of the middle portion of the elastic blade 120.

The projected edge 111 of the supporting member 110 increases the contact pressure of the middle portion of the elastic blade 120 by an amount equivalent to the increase in contact pressure of the end portions of the elastic blade 120 due to pressure exerted by the seal members 130 and 130′. Accordingly, a uniform contact pressure distribution B is obtained. Herein, the entire contact pressure can be properly set by controlling a distance and an angle between the developer roller 230 and the elastic blade 120.

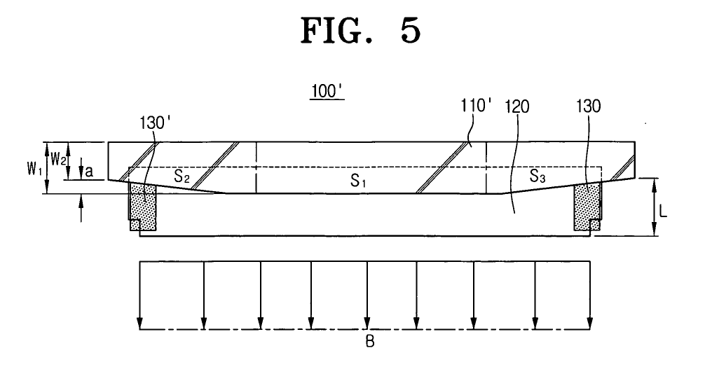

The projected portion edge 111 of the supporting member 110 may be formed as a curved line shape or a straight line shape as shown in FIG. 5. FIG. 5 shows a doctor blade 100′ according to another embodiment of the present invention. In FIG. 5, the edge closest to the developer roller 230 at each end of the supporting member 110′ is tapered. As shown in FIG. 5, the supporting member 110′ has a projected middle portion S1 to increase the contact pressure of the middle portion of the elastic blade 120. Accordingly, the contact pressure is uniformly distributed along the length of the developer roller 230. That is, a uniform distribution B of the contact pressure is obtained.

In embodiments of the present invention, the edge of the projected portion 111 of the supporting member 110 is formed as a curved line shape and a straight line shape as shown in FIGS. 4 and 5. However, the present invention is not limited thereby. That is, the projected portion of the supporting member 110 according to the present invention can be formed as any shape to increase a dimension of the middle portion S1 of the supporting member to increase the contact pressure of the middle portion of the elastic blade 120 and to thus adjust the contact pressure distribution to achieve uniform contact pressure with the developer roller.

In addition, the present invention is not limited to a particular projected length “a” of the middle portion S1 of the supporting member 110. Simulation results indicate that any projected length “a” under 40% of a distance L, where L is measured from a front edge of an end portion of the supporting member 110 to the contact edge 121 of the elastic blade 120, is effective in achieving a uniform contact pressure distribution Bw. If the length of the projected portion “a” is longer than 40% of L, then too much contact pressure is applied. Simulations indicate that 20% of the distance L is preferred. For example, if the distance L is 10 mm, the length “a” of the projected portion is about 2 mm.

The elastic blade 120 includes: a contact edge portion 121 in contact with the rotating developer roller 230 with a predetermined pressure to control the thickness of the toner supplied on the developer roller 230; and a base edge portion 122 fixed to the supporting member 110 with adhesive or a weld. Spot-welding may be performed to join the supporting member 110 and the elastic blade 120. A general spot welder can be used since the joining is along a linear contact line between the supporting member 110 and the base edge 122 of the elastic blade 120. That is, since the spot-welding is performed along a linear line, no specially manufactured welder is required. Specifically, welding is not required along the shape of the projected edge 111 of the middle portion S1 of the supporting member 110. Therefore, a typical welder can be used.

Each of the seal members 130 and 130′ is supported at the toner case 260 and respectively located at each end of the elastic blade 120. The seal members 130, 130′ prevent the toner from leaking past the ends of the elastic blade 120 as the elastic blade 120 controls the thickness of the toner layer formed on the developer roller 230.

The seal members 130 and 130′ cause the uneven toner concentration problems in the printed images in the related art. A beneficial aspect of the present invention is to overcome such a drawback, by allowing the projected edge 111 of the middle portion S1 of the supporting member 110 to project by a predetermined length “a” along the elastic blade 120 toward the contact edge 121 to increase the contact pressure of the middle portion of the elastic blade 120. Accordingly, in an embodiment of the present invention, the contact pressure is uniformly distributed along the elastic blade 120 and the developer roller 230 to resolve the uneven toner concentration problem and improve the image quality.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A doctor blade of an image forming apparatus comprising:
an elastic blade having a first edge contacting a developer roller with a predetermined pressure to control a toner layer formed on the developer roller; and
a supporting member supporting a second edge of the elastic blade,
wherein a size of a middle portion of the supporting member is larger than a size of each end portion of the supporting member.

2. The doctor blade of claim 1, wherein a width W1 of the middle portion of the supporting member is larger than widths W2 and W3 of the respective end portions of the supporting member.

3. The doctor blade of claim 2, wherein the middle portion of the supporting member is projected along the elastic blade toward the first edge of the elastic blade a predetermined amount farther than both end portions of the supporting member.

4. The doctor blade of claim 3, wherein the projected portion of the middle portion of the supporting member forms a curved line shaped edge.

5. The doctor blade of claim 3, wherein the projected portion of the middle portion of the supporting member forms a straight line shaped edge.

6. The doctor blade of claim 3, wherein the projected portion of the middle portion of the supporting member forms a nonlinear shaped edge.

7. The doctor blade of claim 4, wherein a projected distance of the projected portion is set less than 40% of a distance L measured from ends of the supporting member to the first edge of the elastic blade.

8. The doctor blade of claim 7, wherein the projected distance of the projected portion is about 20% of the distance L.

9. The doctor blade of claim 5, wherein a projected distance of the projected portion is set less than 40% of a distance L measured from ends of the supporting member to the first edge of the elastic blade.

10. The doctor blade of claim 9, wherein the projected distance of the projected portion is about 20% of the distance L.

11. A doctor blade of an image forming apparatus comprising:
an elastic blade having a first edge contacting a rotating developer roller with a predetermined pressure to control a thickness of a toner layer on the developer roller;
a supporting member supporting a second edge of the elastic blade; and
seal members respectively mounted on each end of the elastic blade to prevent leakage of a toner,
wherein a size of a middle portion of the supporting member is larger than a size of each end portion of the supporting member to uniformly distribute contact pressure between the elastic blade and the developer roller throughout a length direction of the elastic blade.

12. The doctor blade of claim 11, wherein the middle portion of the supporting member is projected along the elastic blade toward the first edge of the elastic blade by a predetermined distance.

13. The doctor blade of claim 12, wherein the projected portion of the supporting member forms a curved line shaped edge.

14. The doctor blade of claim 12, wherein the projected portion of the supporting member forms a straight line shaped edge.

15. The doctor blade of claim 12, wherein the projected portion of the middle portion of the supporting member forms a nonlinear shaped edge.

16. The doctor blade of claim 13, wherein the projected portion is projected less than 40% of a distance L measured from ends of the end portions of the supporting member to the first edge of the elastic blade.

17. The doctor blade of claim 16, wherein the projected distance of the projected portion is about 20% of the distance L.

18. The doctor blade of claim 15, wherein the projected distance of the projected portion is less than 40% of a distance L measured from ends of the end portions of the supporting member to the first edge of the elastic blade.

19. The doctor blade of claim 18, wherein the projected distance of the projected portion is about 20% of the distance L.

20. A development unit comprising:
a developer roller rotatably arranged to face a photoconductor;
an elastic blade having a first edge contacting the rotating developer roller to control a thickness of a toner layer of the developer roller;
a supporting member supporting a second edge of the elastic blade; and
seal members respectively mounted at each end of the elastic blade to prevent leakage of a toner,
wherein the elastic blade is fixed to the supporting member to have uniform contact pressure between the elastic blade and the developer roller along a length of the developer roller.

21. The development unit of claim 20, wherein the supporting member has a middle portion having a larger size than both end portions.

22. The development unit of claim 21, wherein the middle portion of the supporting member is projected toward the first edge of the elastic blade farther than both end portions of the supporting member.

23. The development unit of claim 22, wherein the projected portion of the supporting member forms a curved line shaped edge.

24. The development unit of claim 22, wherein the projected portion of the supporting member forms a straight line shaped edge.

25. The development unit of claim 22, wherein the projected portion of the supporting member forms a nonlinear shaped edge.

26. The development unit of claim 23, wherein the projected portion is projected a distance less than 40% of a distance L measured from ends of the supporting member to the first edge of the elastic blade.

27. The development unit of claim 26, wherein the projected portion is projected a distance about 20% of the distance L.

28. The development unit of claim 24, wherein the projected portion is projected a distance less than 40% of a distance L measured from ends of the supporting member to the first edge of the elastic blade.

29. The development unit of claim 28, wherein the projected portion is projected a distance about 20% of the distance L.

30. The development unit of claim 20, wherein the supporting member and the elastic blade are adhered by a weld.

31. The development unit of claim 20, wherein the supporting member and the elastic blade are adhered by an adhesive.

32. The development unit of claim 20, wherein the supporting member and the elastic blade are joined by a fastener.

33. A doctor blade of an image forming apparatus comprising:
an elastic blade having a first edge contacting a developer roller with a predetermined pressure to control a toner layer formed on the developer roller; and
a supporting member supporting a second edge of the elastic blade,
wherein the elastic blade is fixed to the supporting member to have uniform contact pressure between the elastic blade and the developer roller along a length of the developer roller.

34. The doctor blade of claim 33, wherein an edge of the supporting member projected long the elastic blade toward the developer roller forms a nonlinear shaped edge.
